(19) United States
(12) Patent Application Publication
(10) Pub. No.: US 2016/0236693 A1
(43) Pub. Date: Aug. 18, 2016

(54) ELECTRIC POWER SUPPLY SYSTEM FOR MACHINE

(71) Applicant: Caterpillar Inc., Peoria, IL (US)

(72) Inventors: William C. Hawkins, Plainfield, IL (US); John F. Kral, Plainfield, IL (US)

(73) Assignee: Caterpillar Inc., Peoria, IL (US)

(21) Appl. No.: 15/135,391

(22) Filed: Apr. 21, 2016

(51) Int. Cl. B61C 17/06; F02N 11/08

(52) U.S. Cl. CPC B61C 17/06; F02N 11/0862

(57) ABSTRACT

An electric power supply system for a machine is provided. The electric power supply system includes a first battery for supplying power to a plurality of electrical components during an operating state of the engine. The electric power supply system includes a first contactor to establish an electric communication between the first battery and the engine for cranking the engine. The electric power supply system includes a second battery for supplying power to plurality of electrical components during a non-operating state of the engine. The electric power supply system includes a second contactor to establish an electric communication between the second battery and the plurality of electrical components. The electric power supply system includes a controller that receives and determines a state of the engine. The controller actuates at least one of the first contactor and the second contactor to communicate the first battery and the second battery.

### TECHNICAL FIELD

The present disclosure relates to an electric power supply system for a machine, and more particularly relates to a method for supplying electric power to electrical components of the machine.

### BACKGROUND

Machines, such as locomotives, on road vehicles and off road vehicles, include an electric power supply system coupled to an engine of the machine. The electric power supply system is provided with a power source, such as a battery. The battery aids in operation of electrical components of the machine and for cranking the engine. The electrical components include a starter motor, an air conditioning unit, a heater, a cabin lighting unit, a high frequency radio, a GPS navigational system, and a lighting unit. The electrical components add to the load which is already handled by the electric power supply system, thereby rendering charge of the electric power supply system insufficient for cranking the engine. In such circumstances, the electrical components may require additional electric power source to be employed in the machine, which in turn adds to the cost of the machine.

U.S. Pat. No. 6,928,972 (the '972 patent) describes a system and method for providing auxiliary power to a large diesel engine, and allowing shut down of the engine on various weather conditions. The system discloses an auxiliary power unit comprising a secondary engine coupled to an electrical generator. The system further discloses an automatic control system to shut down the primary engine prior to a period of idling. The auxiliary power unit further provides electrical power for heating and air conditioning. The auxiliary power unit is adapted to automatically start in response to a low coolant temperature, low battery voltage, and low air reservoir pressure. With such arrangement of having the primary engine and the secondary engine, the '972 patent renders the system complex and increases the maintenance cost.

### SUMMARY OF THE DISCLOSURE

According to an aspect of the present disclosure, an electric power supply system for a machine is provided. The electric power supply system includes a first battery configured to communicate with an engine of the machine. The first battery is further configured to supply power to a plurality of electrical components of the machine during an operating state of the engine. The electric power supply system further includes a first contactor disposed between the first battery and the engine. The first contactor is configured to establish an electric communication between the first battery and the engine upon actuation thereof for cranking the engine. The electric power supply system further includes a second battery configured to communicate with the plurality of electrical components of the machine. The second battery is further configured to supply power to each of the plurality of electrical components during a non-operating state of the engine. The electric power supply system further includes a second contactor disposed between the second battery and at least one the plurality of electrical components. The second contactor is configured to establish an electric communication between the second battery and at least one of the plurality of electrical components upon actuation thereof. The electric power supply system further includes a controller in communication with the first contactor and the second contactor. The controller is configured to receive, via a sensing unit, a signal indicative of at least one of the operating state and the non-operating state of the engine. The controller is further configured to determine a state of the engine based on the signal received from the sensing unit. The controller is further configured to actuate at least one of the first contactor and the second contactor to selectively communicate the first battery and the second battery, respectively, with at least one of the engine and the plurality of electrical components based on the determined state of the engine.

Other features and aspects of this disclosure will be apparent from the following description and the accompanying drawings.

### BRIEF DESCRIPTION OF THE DRAWING

FIG. 1 is a schematic side view of an exemplary machine;

FIG. 2 is a block diagram of an electric power supply system for the machine of FIG. 1, according to an embodiment of the present disclosure; and

FIG. 3 is a flow chart of a method for supplying electric power to electrical components of the machine.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claim.

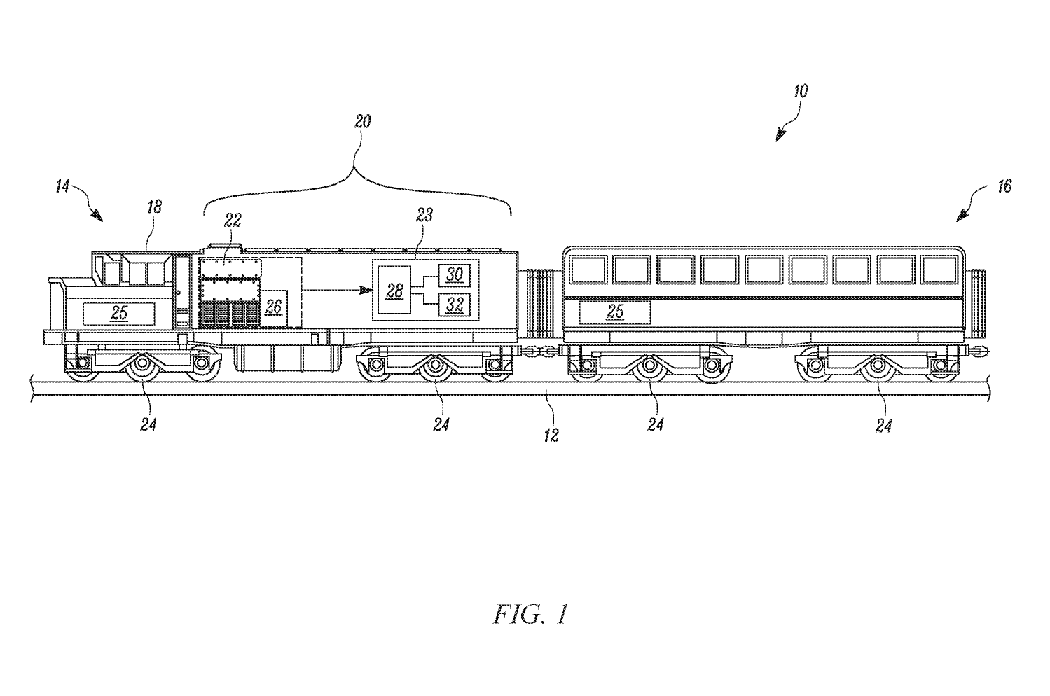

FIG. 1 illustrates a side view of an exemplary machine 10. For the purpose of illustration, the machine 10 is embodied as a locomotive consist. The term “locomotive consist” referred to herein includes two or more compartments that are mechanically coupled to each other to travel on rails 12. The “locomotive consist” may be used for transportation of passengers and cargo. It should be understood that the application of the present disclosure is not restricted to the locomotive consist disclosed herein, and may be extended to an off-highway truck, an on-highway truck, a dump truck, an articulated truck, a loader, and any other machine powered by a prime mover, such as an internal combustion engine

The machine 10 includes an engine car 14 and a passenger car 16 mechanically coupled to each other. The engine car 14 is embodied as a primary compartment, and includes an operator cabin 18 and an enclosure 20. The passenger car 16 is embodied as a trail compartment coupled behind the engine our 14 in a propulsion direction of the machine 10. It should be understood that a number of the engine cars 14 and a number of the passenger cars 16 disclosed herein is exemplary, and may vary based on the application. For example, the machine 10 may include two engine cars 14.

The operator cabin 18 is mounted on a chassis not shown) of the machine 10. In an example, the operator cabin 18 may include an operator interface (not shown) having control levers, switches, and a display, such that an operator controls movement of the machine 10 and perform various operations of the machine 10. In addition to the operator cabin 18, the enclosure 20 is also mounted on the chassis of the machine 10 adjacent to the operator cabin 18. The enclosure 20 is adapted to house various electrical and mechanical components of the machine 10. An engine 22 is housed in the enclosure 20 of the machine 10. In an example, the engine 22 may he one of a diesel engine, a gasoline engine, and a gaseous fuel powered engine, such as a natural gas engine.

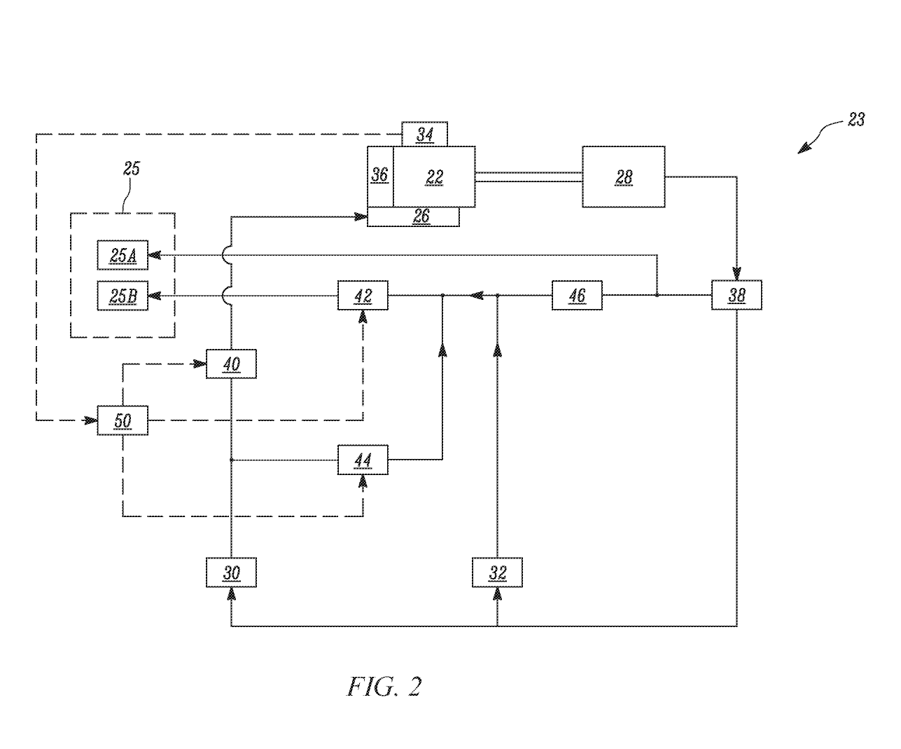

A starter motor 26 is also housed in the enclosure 20 for cranking the engine of the machine 10. In an example, the starter motor 26 may include a drive gear (not shown) that may be actuated to engage with a flywheel 36 (shown in FIG. 2) of the engine 22 for cranking the engine 22. Upon cranking the engine 22, the drive gear of the starter motor 26 may be disengaged from the flywheel 36 (shown in FIG. 2) to allow continuous operation of the engine 22 to generate mechanical power required for propelling the engine our 14 and provide power to various systems of the machine 10. More particularly, the mechanical power thus generated is further transferred to each of the drive trains (not shown) of the engine car 14 and an electric power supply system 23 of the machine 10, On receiving the mechanical power, the drive train delivers rotational power to a set of rail engaging members 24. The set of rail engaging members 24 assists in movement of the machine 10.

The electric power supply system 23 is housed within the enclosure 20 of the machine 10 and is in electric communication with the engine 22. The electric power supply system 23 is configured to supply electric power to a plurality of electrical components 25 of the machine 10. The electric power supply system 23 includes an alternator 28. The alternator 28 receives a drive power from the engine 22 via a gear drive, a chain drive, or a belt drive. The alternator 28 converts the mechanical power into electric power.

The electric power supply system 23 further includes a first battery 30 and a second battery 32 configured to receive the electric power from the alternator 28. Each of the first battery 30 and the second battery 32 may be one of a lead acid battery, a zinc bromine battery, a nickel zinc battery or any such type of battery known in the art. Further, each of the first battery 30 and the second battery 32 is configured to supply the electric power to each of the plurality of electrical components 25 provided in the operator cabin 18 and the passenger car 16 of the machine 10. In an example, the plurality of electrical components 25 may include a Heating Ventilation Air Conditioning (HVAC) Unit, control devices and safety devices. In an example, the control devices may include, but not limited to, the operator interface, a high frequency radio, a GPS navigational system, and an automated start/stop system. The safety devices may include, but not limited to, a cabin lighting unit, a headlamp, and a flasher unit.

During an operating state of the engine 22, the engine 22 is adapted to generate mechanical power, and thereupon transfers the generated mechanical power to the alternator 28. The alternator 28 converts the mechanical power into the electric power. As such, the alternator 28 is configured to charge the first battery 30 and the second battery 32 during the operating state of the engine 21 The first battery 30 and the second battery 32 are configured to store the electric power received from the alternator 28, and further supply the electric power to the plurality of electrical components 25 provided in the operator cabin 18 and the passenger car 16 of the machine 10.

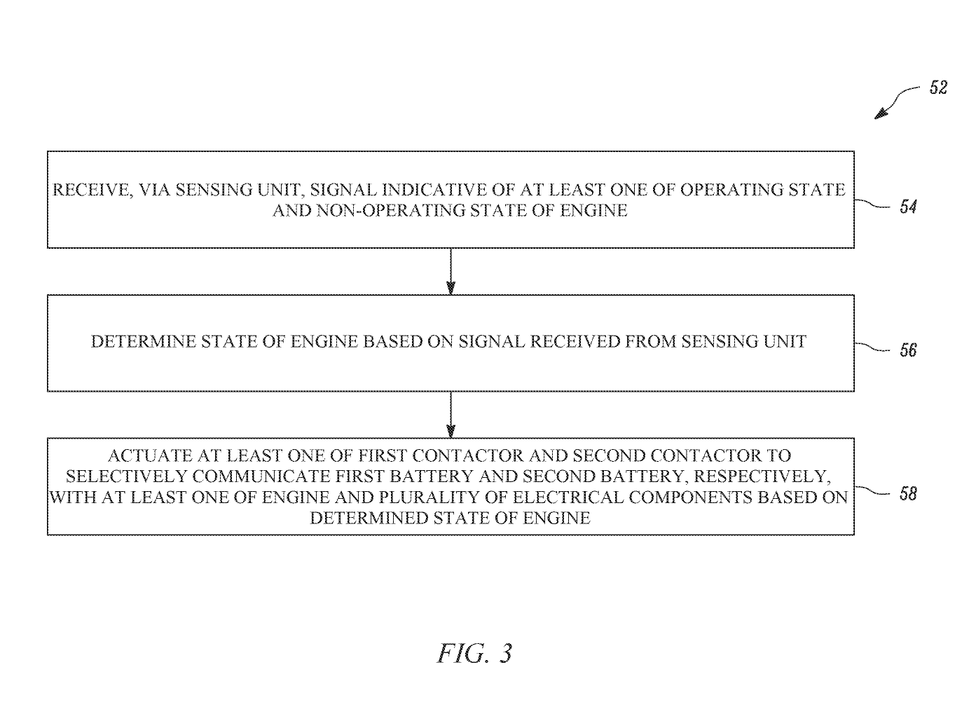

Further, during a non-operating state of the engine 22, the second battery 32 is configured to supply the electric power to the plurality of electrical components 25 provided in the operator cabin 18 and the passenger car 16. The manner in which the first battery 30 and the second battery 32 are operated with respect to the operating state and the non-operating state of the engine 22 is described in FIG. 2 and FIG. 3.

Although the present disclosure herein is described with respect to the starter motor 26 for cranking the engine 22, it will he understood by a person skilled in the art that the electric power supply system 23 may be implemented in any machine having an electric starting system, such as a generator or an invertor for supplying the electric power to the plurality of electrical components 25.

FIG. 2 illustrates a block diagram of the electric power supply system 23. The electric power supply system 23 is configured to supply the electric power to the starter motor 26 and each of the plurality of electrical components 25 provided in the operator cabin 18 and the passenger car 16 of the machine 10. In the present embodiment, the plurality of electrical components 25 are categorized as anon-critical load equipment 25A, such as the HVAC unit, and a critical load equipment 25B, such as the control devices, and the safety devices. The electric power supply system 23 is configured to supply the electric power to the non-critical load equipment 25A during the non-operating state of the engine 22 and the critical load equipment 25B during the operating state and the non-operating state of the engine 22.

The electric power supply system 23 includes a sensing unit 34 for determining a state of the engine 22. The sensing unit 34 is configured to communicate with the engine 22 of the machine 10. In an example, the sensing unit 34 may include plurality of sensors to detect various operating parameters of the engine 22. The plurality of sensors may include a tachometer, a pressure sensor, a temperature sensor and any other sensors known in the art. The sensing unit 34 is configured to receive a signal indicative of various operating parameters of the engine 22, such as speed, oil pressure and oil temperature. The sensing unit 34 may also be configured to receive a signal indicative of various operations performed by an operator within the operator cabin 18 of the machine 10. The state of the engine 22, such as the operating state and the non-operating state is determined based on the signal received from the sensing unit 34.

The first battery 30 is configured to communicate with the starter motor 26 of the engine 22. Specifically, the first battery 30 is configured to supply the electric power to the starter motor 26 when the engine 22 is in the non-operating state. Upon receiving the electric power from the first battery 30, the starter motor 26 actuates the drive gear to engage with the flywheel 36 of the engine 22. As such, the starter motor 26 rotates the flywheel 36 and enables cranking of the flywheel 36 of the engine 22 to generate the mechanical power. After the cranking of the engine 22, in an example, the first contactor 40 may disconnect the electric communication from the first battery 30 to the starter motor 26 to disengage the drive gear from the flywheel 36. Further, in an example, the first battery 30 may be configured to provide the electric power to the critical load equipment 25B during the non-operating state of the engine 22.

The electric power supply system 23 further includes a first contactor 40. The first contactor 40 is disposed between the first battery 30 and the starter motor 26 of the engine 22. In an example, the first contactor 40 may be a mechanical push button, or a contact switch that is normally in an open condition. Upon actuation, the first contactor 40 moves to a closed condition to allow supply of electric current therethrough. In the present embodiment, the first contactor 40 is configured to establish an electric communication between the first battery 30 and the starter motor 26 of the engine 22 upon actuation thereof. In various examples, the first contactor 40 may establish or disconnect the electric communication from the first battery 30 to the starter motor 26 irrespective of the state of the engine 22. In an example, the first contactor 40 may be provided with an electromagnetic coil and a contact. On electrical actuation of the electromagnetic coil, the electromagnetic coil generates a magnetic field and attracts the contact towards the electromagnetic coil. As such the contact allows the supply of the electric power from the first battery 30 to the starter motor 26. Likewise, on electrical de-actuation of the electromagnetic coil, the electromagnetic coil fails to generate the magnetic field and hence fails to attract the contact towards the electromagnetic coil. As such the contact disconnects supply of the electric power from the first battery 30 to the starter motor 26.

The second battery 32 of the electric power supply system 23 is configured to supply the electric power to the critical load equipment 25B of the machine 10 during non-operating state of the engine 22. Further, in an example, the second battery 32 may also be configured to supply the electric power to the critical load equipment 25B of the machine 10 during the operating state of the engine 22. The electric power supply system 23 further includes a second contactor 42, The second contactor 42 is disposed between the second battery 32 and the plurality of electrical components 25 provided in the operator cabin 18 and the passenger car 16. Construction of the second contactor 42 is similar to the construction of the first contactor 40 described above. In the present embodiment, the second contactor 42 is configured to establish an electric communication between the second battery 32 and the plurality of electrical components 25 upon actuation thereof during the non-operating state of the engine 22. More specifically, the second contactor 42 is configured to establish the electric communication to supply the electric power to the critical load equipment 25B during the non-operating state of the engine 22. In various examples, similar to the first contactor 40, the second contactor 42 may establish or disconnect the electric communication from the second battery 32 to the plurality of electrical components 25 irrespective of the state of the engine 22. The electric power supply system 23 further includes a third contactor 44 disposed between the first battery 30 and the critical load equipment 25B. Such that, upon actuation of the third contactor 44, the first battery 30 is configured to provide the electric power to the critical load equipment 25B of the machine 10 irrespective of the state of the engine 22.

The electric power supply system 23 further includes a charging unit 38 in electric communication with the alternator 28. The alternator 28 supplies the electric power to the plurality of electrical components 25 including the non-critical load equipment 25A and the critical load equipment 25B provided in the operator cabin 18 and the passenger car 16 of the machine 10 during operating state of the engine 22.

The charging unit 38 is configured to bifurcate a portion of the electric power from the alternator 28 to each of the first battery 30 and the second battery 32. As such, the charging unit 38 is configured to charge each of the first battery 30 and the second battery 32 during the operating state of the engine 22. In addition, the charging unit 38 is configured to supply the electric power to operate the critical load equipment 25B via a diode 46 and the second contactor 42, and also to supply the electric power to operate the non-critical load equipment 25A. The diode 46 enables the supply of the electric power from the charging unit 38 to the critical load equipment 25B of the plurality of electrical components 25, and restricts reverse flow of electric current.

The electric power supply system 23 further includes a controller 50 configured to selectively supply the electric power to the plurality of electrical components 25 and the starter motor 26 of the engine 22 from the first battery 30 and the second battery 32. The controller 50 is also in communication with the sensing unit 34 and configured to receive the signal from the sensing unit 34. Based on the signal received from the sensing unit 34, the controller 50 determines whether the engine 22 is in the operating state or non-operating state. Based on the state of the engine 22, the controller 50 is configured to communicate with the first contactor 40, the second contactor 42, and the third contactor 44. in an example, the controller 50 may be a processor including a single processing unit or a number of processing units, all of which may include plurality of computing units. The explicit use of term ‘processor’ should not be construed to refer exclusively to hardware capable of executing a software application. Rather, in this example, the controller 50 may be implemented as one or more microprocessors, microcomputers, digital signal processor, central processing units, state machine, logic circuitries, and any device that is capable of manipulating signals based on operational instructions. Among the capabilities mentioned herein, the controller 50 may also he configured to receive, transmit, and execute computer-readable instructions.

in operation of the electric power supply system 23, the sensing unit 34 may monitor various operating parameters, such as an engine speed, oil pressure, and oil temperature, of the engine 22 to determine the state of the engine 22. Accordingly, the sensing unit 34 transmits the signal indicative of the operating parameters of the engine 22 to the controller 50. Upon receiving the signal, if the controller 50 determines that the engine 22 is in the non-operating state, then the controller 50 electrically actuates the first contactor 40. As described earlier, the electrical actuation of the first contactor 40 allows the supply of the electric power from the first battery 30 to the starter motor 26. The starter motor 26 initiates the operation of the engine 22, and thus the mechanical power is generated from the engine 22. Further, the starter motor 26 causes the engine 22 to move to the operating state thereof. In the operating state of the engine 22, the engine 22 transfers the mechanical power to the alternator 28, as such the alternator 28 converts the mechanical power into the electric power. The electric power is in turn supplied to the charging unit 38. The charging unit 38 is configured to charge each of the first battery 30 and the second battery 32. As a result, both the first battery 30 and the second battery 32 are preserved with required electric charge. The charging unit 38 further supplies the electric power to the non-critical load equipment 25A provided in the operator cabin 18 and the passenger car 16 of the machine 10.

In an example, during the operating state of the engine 22, the controller 50 may electrically actuate at least one of the second contactor 42 and the third contactor 44. Upon actuation of the at least one of the second contactor 42 and the third contactor 44, at least one of the first battery 30 and the second battery 32 supplies the electric power to the critical load equipment 25B provided in the operator cabin 18.

Further, upon receiving the signal, if the controller 50 determines that the engine 22 is in the non-operating state, then the controller 50 electrically actuates the second contactor 42 to meet a demand of the electric power required by the plurality of electrical components 25, specifically the critical load equipment 25B. As described earlier, electrical actuation of the second contactor 42 allows supply of the electric power from the second battery 32 to the critical load equipment 25B during the non-operating state of the engine 22.

Further, in an example, during the non-operating state of the engine 22, the first contactor 40 and the third contactor 44 may be in the non-actuated condition. The non-actuated condition of the third contactor 44 disconnects supply of the electric power from the first battery 30 to the critical load equipment 25B. Similarly, in the non-actuated condition, the first contactor 40 disconnects the supply of the electric power from the first battery 30 to the starter motor 26. As a result, the critical load equipment 25B provided in the operator cabin 18 and the passenger car 16 receives the electric power from the second battery 32 during the non-operating state of the engine 22. Further, the first battery 30 remains completely charged during the non-operating state of the engine 22, to supply the electric power to the starter motor 26 during cranking of the engine 22.

### INDUSTRIAL APPLICABILITY

The present disclosure relates to the electric power supply system 23 for the machine 10, and a method 52 of supplying the electric power to the plurality of electrical components 25 of the machine 10. The charging unit 38 provided in the electric power supply system 23 enables charging of each of the first battery 30 and the second battery 32 during the operating state of the engine 22. The second battery 32 is configured to supply the electric power to the plurality of electrical components 25 provided in the operator cabin 18 and the passenger car 16 of the machine 10 during the non-operating state of the engine 22. As such, the electric charge of the first battery 30 is preserved during the non-operating state of the engine 22 to supply the electric power to the starter motor 26 during cranking of the engine 22.

FIG. 3 is a flow chart of the method 52 for supplying the electric power to the plurality of electrical components 25 of the machine 10, The steps in which the method 52 is described are not intended to be construed as a limitation, and any number of steps can be combined in any order to implement the method 52. Further, the method 52 may be implemented in any suitable hardware, such that the hardware employed can perform the steps of the method 52 readily and on a real-time basis.

For the purpose of illustration, various steps of the method 52 are described in conjunction with FIGS. 1 and 2. At step 54, the method 52 includes receiving the signal indicative of at least one of the operating state and the non-operating state of the engine 22 from the sensing unit 34 by the controller 50. The sensing unit 34 is in electric communication with the controller 50. The sensing unit 34 monitors the various operating parameters including, but not limited to, the engine speed, the oil pressure, and the oil temperature of the engine 22. Accordingly, the sensing unit 34 transmits the signal indicative of the non-operating state or operating state of the engine 22. At step 56, the method 52 includes determining the state of the engine 22 based on the signal received from the sensing unit 34. The controller 50 in communication with the sensing unit 34 receives the signal and determines whether the engine 22 is in the operating state or the non-operating state. At step 58, the controller 50 actuates one of the first contactor 40 and the second contactor 42 with respect to the state of the engine 22. During the non-operating state of the engine 22, the controller 50 actuates the first contactor 40 to allow communication between the first battery 30 and the starter motor 26 of the engine 22 for cranking the engine 22, Further, during the non-operating state of the engine 22, the controller 50 actuates the second contactor 42 to selectively communicate the second battery 32 with the plurality of electrical components 25 provided in the operator cabin 18 and the passenger car 16 of the machine 10.

As such, the first battery 30 disclosed in the present disclosure is electrically disconnected by the first contactor 40 during the non-operating state of the engine 22, The electrical disconnection of the first battery 30 enables preservation of electric charge in the first battery 30, and thereby enabling the first battery 30 to supply the electric power required by the starter motor 26 for cranking the engine 22. The second battery 32 disclosed in the present disclosure supplies the electric power required to operate the plurality of electrical components 25 provided in the operator cabin 18 and the passenger car 16 of the machine 10 during the non-operating state of the engine 22.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An electric power supply system for a machine, the electric power supply system comprising:
a first battery configured to communicate with an engine of the machine, and supply power to a plurality of electrical components during an operating state of the engine;
a first contactor disposed between the first battery and the engine, and configured to establish an electric communication between the first battery and the engine upon actuation thereof for cranking the engine;
a second battery configured to communicate with the plurality of electrical components of the machine, and supply power to each of the plurality of electrical components during a non-operating state of the engine;
a second contactor disposed between the second battery and at least one the plurality of electrical components, and configured to establish an electric communication between the second battery and at least one of the plurality of electrical components upon actuation thereof; and
a controller in communication with the first contactor, and the second contactor, the controller configured to:
receive, via a sensing unit, a signal indicative of at least one of the operating state and the non-operating state of the engine;
determine a state of the engine based on the signal received from the sensing unit; and
actuate at least one of the first contactor and the second contactor to selectively communicate the first battery and the second battery, respectively, with at least one of the engine and the plurality of electrical components based on the determined state of the engine.
